(19) United States
(12) Patent Application Publication
(10) Pub. No.: US 2011/0001429 A1
(43) Pub. Date: Jan. 6, 2011

(54) Three-dimensional display system

(76) Inventor: Neal Edwin Davis, Champaign, IL (US)

Correspondence Address: Neal Davis, 1006 E Oregon St, Urbana, IL, 61801, US

(21) Appl. No.: 12/459,528

(22) Filed: Jul. 1, 2009

(51) Int. Cl. H05H 1/48

(52) U.S. Cl. 315/111.21

(57) ABSTRACT

A three-dimensional display system is provided which promises to project an image into a volume. The three-dimensional display system produces visible light in a volume at the intersection of two laser beams by forming a plasma at a volume element within the volume and exciting target molecules within the plasma into an excited energy state. The target molecules are characterized by sufficiently sizeable energy state transitions such that visible light is emitted upon transition of the target molecules from an excited energy state to a lower energy state. By rapidly repeating this process according to three-dimensional image data, one or more embodiments of the present invention is able to project a three-dimensional image into a volume without many of the drawbacks of earlier machines.

### BACKGROUND OF THE INVENTION

One or more embodiments of the present invention generally relates to a display system. More particularly, one or more embodiments of the present invention relates to a three-dimensional volumetric display system. The system activates volume elements within a volume to produce light energy. By activating target molecules at different volume elements within the volume, the system is able to produce light energy in the form of a three-dimensional image.

Numerous image display systems abound. Indeed, in its simplest form, a display system is nothing more than a system to represent an image. The image may not be complex; it may be a simple alphanumeric character, a basic geometric shape, or even just a random collection of points. There are numerous basic display systems available that may accommodate such simple images. A basic image display system may include nothing more than pencil and paper, chalk and chalkboard, or coal and canvas. Though these basic display systems are available to display the simplest of images, it is the more complex display system that may be of greater interest.

Early efforts at complex display systems were mechanical in nature. Designed in the early eras of human history, as they were, mechanical display systems used very little electrical energy. They also tended to display textual images rather than pictures, graphics, or other special effects. For instance, the ticker tape stock telegraph printing devices employed by telegraph companies in the late 1800's were mechanical display systems aimed at simple alphanumeric images: namely, stock prices. An even earlier example of a mechanical display system is the printing press, which simply applied pressure and ink to a medium, such as paper or cloth, to produce an image.

Other mechanical display devices that have been developed over the years are still used today. These display systems tend to have low power consumption and high visibility in most lighting conditions. Split-flap displays, or simply flap displays, are display devices that are commonly used to present alphanumeric text and simple fixed graphics, such as logos. The text or graphics are painted or otherwise put on a collection of flaps which are precisely rotated to show the desired character or graphic. Although digital image display systems are becoming more common, these split-flap display systems may still be seen today in train stations and airports where they typically display departure and/or arrival information.

Flip-disc displays, or flip-dot displays, are sometimes used instead of split-flap displays in a similar fashion. Flip-disc displays use an electromagnetic dot matrix technology to display images—typically alphanumeric characters. The matrix typically includes small metal discs that are black on one side and brightly colored on the other, set into a black background. With the help of a little electronic power, the discs may be flipped to show the other side. Once flipped, the discs stay in position without needing any power. By flipping discs in the matrix in a coordinated pattern, a coherent alphanumeric image may be displayed. Such flip-disc displays are normally used in large outdoor signs that are exposed to direct sunlight, such as on buses or public information displays, although they have also been used on game shows such as Family Feud.

Rolling signs, or just roll signs, are another kind of mechanical display system used in conjunction with, or instead of, flip-disc and split-flap displays. The system simply includes a long sheet of reinforced material, typically paper, attached to two rollers. Roll signs are commonly used on buses, trams and subway carts, with the names of the destinations displayed on the long sheet of reinforced material. When the displayed name needs to change on a roll sign an operator simply turns a handle, causing the next displayed name to, appropriately enough, roll into place.

With the advent of electricity and electronics, more advanced display systems became available. Electrical power was used to power signs lit by incandescent and fluorescent bulbs, as well as neon lights. Complex electronic display systems became accessible and widely used as well. The light emitting diode (LED) was invented as an electronic component that may be used in electrically powered display systems. The small size, low cost and energy efficiency of LEDs made them an attractive and alternative option for use in signs and display systems. Modern LEDs are still widely used in electronic signs and displays in stadiums, airports, railway stations and other common display systems.

Televisions comprise an exceedingly well-known category of electronic display systems. Television (or TV) is a widely used electronic display system that specializes in transmitting and receiving moving images. Commercially available since the late 1930s, the television set has become a common display device in homes, business, and institutions, particularly as a source of entertainment and news. The elements of a broadcast television system generally include an image source, a sound source, a transmitter, a receiver and a display device. Cathode ray tubes (CRTS) constitute the most common and least expensive kind of display device used in televisions. Recent advances in technology have presented flat-panel TVs as a highly sought-after alternative to the standard CRT TV.

Flat-panel TVs generally come in two different design formats: liquid crystal display (LCD) or plasma display panel (PDP). An LCD is an electronically modulated optical display device shaped into a thin, flat panel. The LCD display is made up of any number of color or monochrome pixels filled with liquid crystals and arrayed in front of a light source or reflector. In contrast, PDPs constitute a distinct class of lightweight flat screen display technology that uses the properties of plasma to display two-dimensional images. Many tiny cells in PDPs hold an inert mixture of noble gases between two panels of glass. The gas in the cells is electrically turned into a plasma, which then excites phosphors to emit light. Both LCDs and PDPs have become widely used in recent years.

Still, all of the display systems described above are two-dimensional display systems. Mechanical flip disc and roll sign displays, electronic bulb and LED displays, and the various available television displays are all limited to displaying images in two dimensions. Three-dimensional display is beyond their capacity. However, some display systems are able to display images in three dimensions.

One of the most well known three-dimensional display systems uses paper glasses to make a motion picture appear three-dimensional to the viewer. Three-dimensional glasses typically allow the viewer to look at two images of the same thing taken from a slightly different view point. When the brain reconciles the two images, they combine to form a stereoscopic effect; giving the motion picture, and the viewer, the appearance of three-dimensional depth.

In real life, binocular vision accounts for the perception of depth in three dimensions. Since the eyes are about two inches apart, they see the same image from slightly different angles. The brain's correlation of the two images seen by the eyes is termed binocular vision. Three-dimensional glasses take advantage of binocular vision by presenting each eye with a different image, or rather the same image viewed from slightly different positions. A three-dimensional film viewed without the three-dimensional glasses may appear to be fuzzy or out focus, as the same scene is typically projected on screen simultaneously from two different angles. The filters on the three-dimensional glasses allow only one version of each image to enter each eye, and the viewer's binocular vision does the rest.

Some three-dimensional glasses use color filters, where one lens is red and the other is blue, such that one eye may see only images in blue, and the other may see only images in red. However, image quality in these systems may be poor, as one may not have a good color movie when using color to provide the three-dimensional effect. The preferred method uses polarized lenses because they allow for color viewing. In the polarization method, two synchronized projectors project two respective views onto the screen, each with a different polarization. Three-dimensional glasses with polarized lenses allow only one image into each eye because each lens has a different polarization. Thus, polarized three-dimensional glasses do not rely on color for the three-dimensional effect and, therefore, the quality of the motion picture experience is much improved.

Other three-dimensional systems forego glasses in their attempt to create the illusion of three dimensions in favor of other techniques and designs. For instance, some three-dimensional display systems use rotating displays to create a three-dimensional effect.

Hirsch, U.S. Pat. No. 2,967,905, describes such a system, designed as far back as 1961, where a series of images are presented in rapid succession on a rotating surface, thereby presenting to an observer a three-dimensional image of an object.

Similarly, Batchko, U.S. Pat. No. 5,148,310, discloses a system of rotating reflectors and a rotating flat screen upon which a two-dimensional scanned image is projected. Batchko's rotating screen decodes the image and creates a three-dimensional display of the image in a cylindrical volume of space.

Along the same lines, Blundell, U.S. Pat. No. 5,703,606, discloses a display device comprised of an evacuated enclosure within which a phosphor coated screen is rotated, wherein one or more electron guns write sequential image frames onto the rotating phosphor coated screen to create a three-dimensional effect. By firing electron guns at points on the phosphor screen, Blundell's display system excites the electrons at that point into a higher energy state, producing visible light from the energy that is emitted when the electrons transition back into their normal ground energy states.

Also, Garcia, U.S. Pat. No. 5,042,909, describes a three-dimensional display system using a rotating display, wherein a scanned light beam is displayed upon a disk-like screen, and an image is formed on the screen by projecting the light beam through a modulator, toward a scanner, and onto the screen—thereby creating a three-dimensional effect through the movement of the displayed image on the screen. While the moving screen approach may provide acceptable volumetric images, a device that requires a rapidly moving screen coordinated with other supporting components may be difficult to manufacture and prone to malfunction.

Another method for producing three-dimensional images, besides using three-dimensional glasses or rotating screens, is to use intersecting beams in an appropriate medium. Howell, U.S. Pat. No. 2,604,607 describes a three-dimensional indicator invention from the earlier half of the twentieth century that indirectly uses intersecting electron beams to display a three-dimensional image. However, the intersecting electron beams in Howell's three-dimensional indicator do not produce any illumination from their intersection. Also, Howell's three-dimensional indicator teaches the use of intersecting electron beams within a cathode ray tube.

Similarly, Rowe, U.S. Pat. No. 4,063,233, describes a three-dimensional display device that directs a plurality of electron beams to intersect within a CRT.

In contrast, Swainson, U.S. Pat. No. 4,041,476, describes a method and apparatus in which a three-dimensional figure is formed through the intersection of two radiation beams outside of a cathode ray tube. Instead of a CRT, Swainson's method and apparatus operates in a medium having two active components. While these methods may work, they are constrained to operating within specific contexts; i.e. either within a cathode ray tube or with a narrowly defined set of (usually solid) media.

Thus, although visualization systems exist, most prior development has been in two-dimensional systems which produce the appearance of three-dimensionality. Existing three-dimensional space-occupying systems utilize a spinning screen onto which an image is projected, activate only within small enclosures, or require complex liquids or solids to work.

### BRIEF SUMMARY OF THE INVENTION

One or more of the embodiments of the present invention provide a system relating to three-dimensional display. The three-dimensional display system produces visible light in a volume at the intersection of two laser beams by forming a plasma at a volume element within the volume and exciting target molecules within the plasma into an excited energy state. The target molecules are characterized by sufficiently sizeable energy state transitions such that visible light is emitted upon transition of the target molecules from an excited energy state to a lower energy state. By rapidly repeating this process according to three-dimensional image data, one or more embodiments of the present invention is able to project a three-dimensional image into a volume without many of the drawbacks of earlier machines.

### BRIEF DESCRIPTION OF THE DRAWINGS

FIG. 1 illustrates a three-dimensional display system, according to the preferred embodiment of the present invention.

FIG. 2 illustrates a more detailed view of the three-dimensional display system 100 according to the preferred embodiment of the present invention.

FIG. 3 illustrates a flow chart showing the operation of the three-dimensional display system according to the preferred embodiment of the invention.

FIG. 4 illustrates a more detailed view of the first set of mirrors according to the preferred embodiment of the present invention.

FIG. 5 illustrates a more detailed view of the lens, according to the preferred embodiment of the present invention.

### DETAILED DESCRIPTION OF THE INVENTION

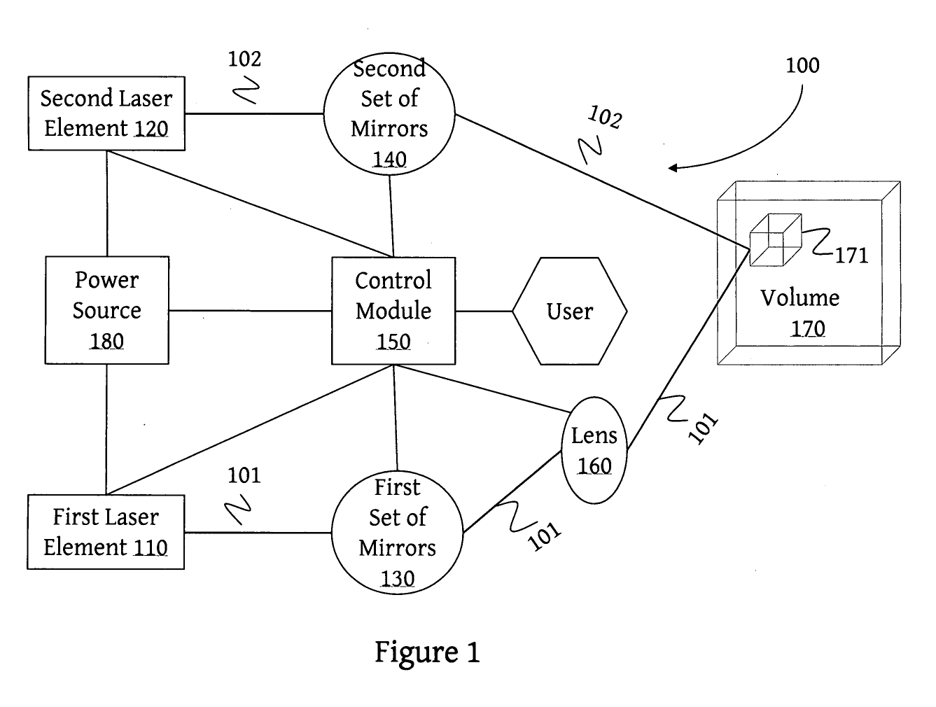

FIG. 1 illustrates a three-dimensional display system 100 according to the preferred embodiment of the present invention. The three-dimensional display system 100 includes two laser elements: a first laser element 110, and a second laser element 120. The first laser element 110 is preferably a laser capable of ionizing gas-phase molecules into a plasma. Although lasers such as titanium-sapphire lasers (Ti:sapphire) are often used, in practice any laser capable of achieving a power density great enough to induce breakdown into the plasma state is suitable. The second laser element 120 is preferably a laser that may be used to excite ionized molecules into an excited energy state. The first and second laser elements, 110 and 120, of the three dimensional display system 100, fire first and second laser beams, 101 and 102, respectively.

The three-dimensional display system 100 also includes two sets, of mirrors corresponding to the two laser elements: a first set of mirrors 130 and a second set of mirrors 140. Each set of mirrors may include a plurality of reflective mirrors. The first and second set of mirrors, 130 and 140, may also include a system for adjusting the location and angle of the mirrors. The two sets of mirrors assist the three-dimensional display system 100 in controlling the direction of the first and second laser beams, 101 and 102, emitted from the first and second laser elements, 110 and 120.

A control module 150 is also included in the three-dimensional display system 100. The control module 150 may be a computer or computer type device capable of performing sufficiently complex computations in sufficiently short periods of time, and in conjunction with sufficient memory capacity, as to be suitable for operation as part of the control module 150. A lens 160 is included, which is preferably a convex lens, as is a power source 180, which provides power to the electrical components of the three-dimensional display system 100. The three-dimensional display system 100 may alternatively include a plurality of lenses. The control module 150 may also adjust the direction, orientation, and location of the lens, or lenses, 160.

The three-dimensional display system 100 may also include a volume 170. The volume 170 may include a plurality of volume elements, 171. Each volume element 171 may represent a finite amount of space within the volume 170. The three-dimensional system 100 may operate on individual volume elements 171 within the volume 170.

Ideally, the volume 170, and its volume elements 171, may be at atmospheric pressure. Alternatively, the volume 170 may be under partial vacuum. If at atmospheric pressure, the volume 170 may not have to be in some sort of physically bounded area. On the other hand, a volume 170 under partial vacuum may have to be in a physically bounded area. In either case, the volume 170 may typically include a gas medium. This gas medium may be made up of target molecules. “Target molecules” here means a species such as N₂, He, Ar, Ne or any other species that features a major energetic transition of the desired frequency. There may be target molecules within the volume elements 171 of the volume 170. The energy transition of target molecules in the volume 170, and the volume elements 171, may produce the visible light emissions that make up a three-dimensional image.

All electrical elements of the three-dimensional display system 100 may preferably be supplied with electricity. A power source 180 may be used to distribute electricity and electrical power to the desired electrical components. A system for transporting this electrical power, typically power cables and electrical wiring, may be employed to connect the power source 180 to the first laser element 110, second laser element 120, and control module 150.

In addition to the power source 180, the control module 150 may connect to the first laser element 110 and first set of mirrors 130, the second laser element 120 and second set of mirrors 140, and the lens 160. The connection to the mirrors 130 and 140 and lens 160 may include a system for controlling various aspects of the first set of mirrors 130, second set of mirrors 140, and lens 160. In particular, the control module 150 may include a system to communicate with and adjust the direction, orientation and location of the first set of mirrors 130, second set of mirrors 140, and lens 160. The control module 150 may also include a system to communicate with and fire the first laser element 110 and second laser element 120. Additionally, the control module 150 may have a system to connect and communicate with the outside world in general, and an outside user in particular.

In operation, the three-dimensional display system 100 operates as a system for volumetric projection. The system uses laser-induced luminescence to project volumetric visual data. “Luminescence” in this instance may include fluorescence, phosphorescence, or other similar light-emitting effects. To create this luminescent effect, first the target molecules may be put into a plasma state by the first laser beam 101 of the first laser element 110, as further described below. Then energy may be introduced into the target molecules in the volume element 171 by the second laser beam 102 of the second laser element 120, exciting them into an excited energy state, as further described below. When the target molecules transition from their excited energy state back to their lower and more stable ground-energy state, or an intermediate energy state, energy in the form of electromagnetic radiation may be emitted. Assuming the energy state transition of the target molecules is sizeable enough to produce energy of the desired frequencies, the emitted energy may be in the form of visible light. Repeating this process may result in the emission of a plurality of photons of visible light from the volume element 171. The display system 100 may thus create the appearance of a three-dimensional image by stimulating the emission of visible light at the appropriate volume elements 171 in the volume 170, as further described below.

In order for the three-dimensional display system 100 to induce luminescence, it first ionizes the target molecules into a plasma state. Plasma is a partially ionized gas in which a fraction of electrons are free instead of bound to an atom or molecule, thus constituting an electrically neutral substance of positive and negative particles. Plasma is considered to be a distinct physical state of matter, as it has properties unlike those of solids, liquids or gases. The three-dimensional display system 100, takes advantage of some of the unique properties of plasma in its operation.

The process of forming a plasma begins when the first laser element 110 fires the first laser beam 101. The first laser element 110 is preferably a laser capable of ionizing gas-phase molecules into a plasma. Although lasers such as titanium-sapphire lasers (Ti:sapphire) are often used, in practice any laser capable of achieving a power density great enough to induce breakdown into the plasma state is suitable. The first laser element 110 may fire the first laser beam 101 under the control of a control signal from the control module 150. The first laser beam 101 may then reflect off of all, some or none of the first set of mirrors 130, depending on the intended direction of the first laser beam 101. The first laser beam 101 may then pass though a lens 160. The lens 160 focuses the first laser beam 101 on a desired volume element 171 in the volume 170. Whereas the first set of mirrors 130 may alter the direction of the first laser beam 101, the lens 160 may affect how far into the volume 170 the first laser beam 101 proceeds before inducing a plasma. Target molecules resident at the focal point of the first laser beam 101 in the volume 170 are ionized by the first laser beam 101 and put into a plasma state. After the first laser beam 101, fired from the first laser element 110, reflects off the first set of mirrors 130 and is focused through the lens 160 on the desired volume element 171, the first laser beam 101 transfers its energy to the target molecules at the volume element 171, thereby putting the target molecules at the volume element 171 into a plasma state.

Once the target molecules have been put into a plasma state, they may be injected with energy and excited to an excited energy state. The second laser element 120 is used for this purpose, and is typically a laser that may be used to excite ionized molecules into an excited energy state. The second laser beam 102, fired from the second laser element 120, is used to excite the target molecules into an excited energy state at the desired volume element 171 in the volume 170. The second laser element 120 may fire the second laser beam 102 under the control of a control signal from the control module 150. The second laser beam 102 may then reflect off of all, some, or none of the second set of mirrors 140, depending on the intended direction of the second laser beam. In general, the second set of mirrors 140 may operate to direct the second laser beam 102 so that it intersects with the target molecules that the first laser beam 101 of the first laser element 110 put into a plasma state. Transitioning from the target molecules' excited energy state to the original ground-energy state, or an intermediate energy state, typically causes an emission of energy. Assuming the energy state transition of the target molecules is sizeable enough to produce energy of the desired frequencies, the emitted energy may be in the form of visible light.

The three-dimensional display system 100 displays a three-dimensional image by iterating the above process. The control module 150 generally directs this iteration. Wherever and whenever a volume element 171 of visible light is desired in the volume 170, the control module 150 may direct both laser elements, 110 and 120, to fire their respective laser beams at that volume element 171 in the volume 170. Additionally, the control module 150 may modify the orientation and location of the first and second sets of mirrors, 130 and 140, as well as the lens 160, in order to ensure the first and second laser beams, 101 and 102, intersect at the desired volume element 171 in the volume 170. The first laser beam 101 thereby induces a plasma at the desired volume element 171 while the second laser beam 102 excites the target molecules in that volume element 171 of plasma into an excited energy state. The transition of the target molecules from an excited energy state to a lower energy state may produce a luminescent effect in which visible light energy is emitted at the desired volume element 171. The three-dimensional display system 100 may repeat this process as needed, inducing luminescence at a plurality of volume elements 171 within the volume 170, to create the appearance of a three-dimensional image. Ideally, persistence of vision may lead the luminescent effect at any given volume element 171 to be retained in a viewer's eye for sufficient time such that the emission of visible light of the sum of all the volume elements 171 in the volume 170 appears to be in the form of a three-dimensional image.

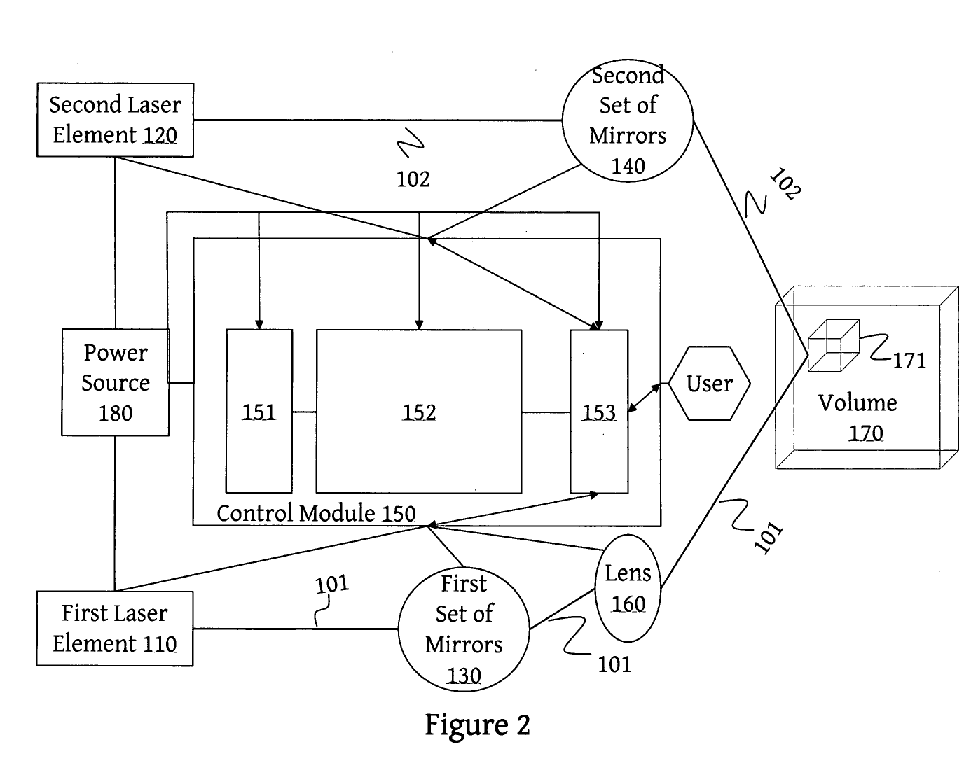

FIG. 2 illustrates a more detailed view of the three-dimensional display system 100 according to the preferred embodiment of the present invention. As detailed above, the three-dimensional display system 100 includes a first laser element 110, a second laser element 120, a first laser beam 101, a second laser beam 102, a first set of mirrors 130, a second set of mirrors 140, a power source 180, a volume 170, a plurality of volume elements 171, and a control module 150. FIG. 2 features an expanded and more detailed illustration of the control module 150.

As shown in FIG. 2, the control module 150 may include a memory unit 151, a central processing unit (CPU) 152, and an input/output (I/O) unit 153. All or a portion of the control module 150 may be embodied in one or more computers. Alternatively, the control module 150 may be embodied in separate electrical components. The control module 150 may also include components not illustrated in FIG. 2 but known to those of ordinary skill in the art.

The components of the control module 150 shown in FIG. 2 are connected to the various elements of the three-dimensional display system 100. The power source 180 is connected to, and provides power to, the memory unit 151, the CPU 152, and the I/O unit 153. In turn, the I/O unit 153 connects to the first and second laser elements, 110 and 120, the first and second set of mirrors, 140 and 130, and the lens 160. Internally, both the memory unit 151 and I/O unit 153 connect to the CPU 152. Additionally, the I/O unit 153 may have a user interface to connect to and communicate with an outside user. Such a system may include a standard computer keyboard and mouse, or any other such computer equipment known to those of ordinary skill in the art allowing for a user to provide input.

In operation, three-dimensional image data may be directly streamed or stored in the memory unit 151. The three-dimensional image data may be previously loaded onto the memory unit 151, be inputted by an outside user through the I/O unit 153 and sent to the memory unit 151, or otherwise provided to the memory unit 151 by a system known to those of ordinary skill in the art. Alternatively, three-dimensional image data may be directly streamed through the I/O unit 153. The three-dimensional image data may depict a single, stationary, still-life image, or a sequence of images, or some combination of these. The three-dimensional image data may further describe, in machine-readable instructions, the manner in which the control module 150 may produce the three-dimensional image described in the context of the three-dimensional image display system 100. Alternatively, the CPU 152 may translate the three-dimensional image data into machine readable instructions that describe the way in which the control module 150, and the three-dimensional display system 100 in general, may produce the three-dimensional image described in the three-dimensional image data. In any case, the control module 150 may store three-dimensional image data, and machine readable instructions for producing the three-dimensional image described by the three-dimensional image data, in the memory unit 151, or directly stream the three-dimensional data through the I/O unit 153.

The CPU 152 operates on data from both the memory unit 151 and I/O unit 153. As explained above, the CPU 152 may perform data translations on the three-dimensional image data stored in the memory unit 151 as needed. Also, the CPU 152 may compile control signals to send through the I/O unit 153 to the various other components of the three-dimensional display system 100. The CPU 152 may perform numerous additional processing functions known to those of ordinary skill in the art in order to effectively administer the operation of the three-dimensional display system 100.

The control module 150 interacts with other components of the three-dimensional display system 100, as well as with outside users, through the I/O unit 153. The I/O unit 153 of the control module 150 may send output control signals to the various components of the three-dimensional display system 100. For instance, the I/O unit 153 may send a control signal to the first laser element 110 or second laser element 120 when it is time for the respective laser element to fire its laser beam. Likewise, a control signal may be sent from the I/O unit 153 to the first and second set of mirrors, 130 and 140, or the lens 160, in order to make adjustments to the position and/or angle of the mirrors or lens in anticipation of an incoming laser beam. These output control signals may be compiled by the CPU 152, or taken straight from the memory unit 151.

The I/O unit 153 may also receive input control signals from the various components of the three-dimensional display system 100. These input control signals may describe the status of the component. For example, the I/O unit 153 may receive an input control signal from the first or second laser elements, 110 and 120, to indicate the element successfully fired its laser beam. In the same fashion, the first or second set of mirrors, 130 or 140, may send an input control signal to the I/O unit 153 indicating the present angle and position of the mirrors. Likewise, the lens 160 may send an input control signal to the I/O unit 153 indicating the present angle and position of the lens 160. Regardless of the actual input control signal content, the I/O unit 153 may store the information embedded in the input control signals it receives in the memory unit 151, or it may send the information embedded in the input signals it receives to the CPU 152 for processing, or it may do both.

of course, as explained above, the functionality of the control module 150 may be implemented in a computer. Even in such an embodiment, however, the operation may be largely the same. Alternatively, a plurality of computers may be used to implement the control module 150, with one or more computers corresponding to one or more components of the control module 150.

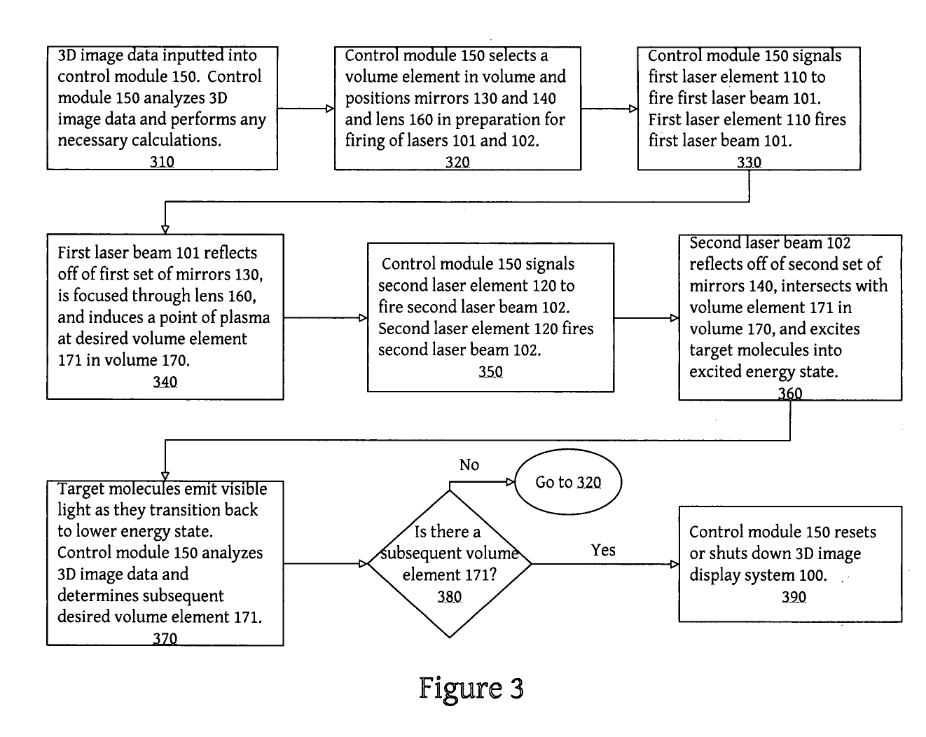

FIG. 3 illustrates the operation of the three-dimensional display system 100 according to an embodiment of the invention. The operation of the three-dimensional display system 100 is illustrated in the form of a flow chart diagram. Each step in the illustrated flow chart diagram may correspond to one or more operations in the three-dimensional display system 100.

At step 310, three-dimensional image data is inputted into the memory unit 151 of the control module 150. The three-dimensional image data may be inputted in a variety of ways, as detailed above. Additionally, the CPU 152 of the control module may perform initial computations and translations on the three-dimensional image data to put it into the proper format if necessary. The control module 150 may also determine whether the three-dimensional image data describes a static image or a dynamic animation and make adjustments accordingly.

Step 320 marks the start of an iterative process of laser-induced luminescence, by which the three-dimensional display system induces the emission of visible light in the volume 170. Each iterative process cycle induces the emission of a single volume element 171 of visible light. Each subsequent process cycle typically induces the emission of visible light at a different volume element 171 than the previous process cycle, although this may vary depending on the actual three-dimensional image data to be displayed. If the three-dimensional image data describes a single static image the iterative process may terminate after a preset amount of time expires, or a given number of image refresh iterations take place. If the three-dimensional image data describes a sequence of images, such as in an animation, the iterative process may terminate after the animation is completed, or after a predetermined number of animation cycles has completed, or after a preset amount of time expires, or some combination of the above. Each iteration of the process begins at step 320, until the iterative process terminates.

At step 320 the control module selects a volume element 171 in the volume 170 at which to induce luminescence. Though the control module 150 may consider and scan through every volume element 171 in the volume 170, the display system 100 may only induce luminescence at certain volume elements 171 in the volume in order to produce the three-dimensional image described by the three-dimensional image data. At step 320, the control module 150 iterates to the first such volume element 171, or the next such volume element 171 if this is a subsequent iteration. The control module 150 may then calculate the appropriate position and angle that the first and second set of mirrors, 130 and 140, and lens 160 may be put in order for the first and second laser beams, 101 and 102, to intersect at the volume element 171. The control module 150 may then send a corresponding output control signal to the first and second set of mirrors, 130 and 140, and lens 160. The first and second set of mirrors, 130 and 140, and lens 160 may reposition themselves accordingly in response to the output control signal from the control module 150 such that a first or second laser beam, 101 or 102, fired from the first or second laser element, 110 or 120, may reflect off the mirrors in the first or second set of mirrors 130 or 140 and intersect with the desired volume element 171 in the volume 170.

At step 330 the I/O unit 153 of the control module 150 signals the first laser element 110 that it is time to fire its first laser beam 101. The first laser element 110 receives the signal and fires a first laser beam 101. At step 340 the first laser beam 101 reflects off of the plurality of mirrors in the first set of mirrors 130 in order to put it along the correct path towards the desired volume element 171. After the first laser beam 101 is reflected off of the final mirror in the first set of mirrors 130 the first laser beam 101 is focused in on the desired volume element 171 through the lens 160. Whereas the first set of mirrors 130 may alter the direction of the first laser beam 101, the lens 160 may alter the life span of the first laser beam 101, effecting how far into the volume 170 the first laser beam 101 proceeds before inducing a plasma. After the first laser beam 101, fired from the first laser element 110, reflects off the first set of mirrors 130 and is focused through the lens 160 onto the desired volume element 171, the first laser beam 101 transfers its energy to the target molecules at the volume element 171, thereby putting the target molecules at that volume element 171 into a plasma state.

At step 350 the control module 150 signals the second laser element 120 that it is time to fire its second laser beam 102. The second laser element 120 receives the signal and fires a second laser beam 102. At step 360 the second laser beam 102 reflects off of the plurality of mirrors in the second set of mirrors 140 in order to put the second laser beam 102 along the correct path towards the volume element 171 in the volume 170 that was previously put into a plasma state by the first laser beam 101 at step 340. When the second laser beam 102, fired from the second laser element 120, intersects with the volume element 171 in the volume 170, it excites the target molecules at that volume element 171 into an excited energy state.

At step 370, luminescence takes effect. The target molecules that were excited into an excited energy state by the second laser beam 102 in step 360 revert to a more stable, lower-energy state. Energy, in the form of electromagnetic waves, is emitted upon transition of the target molecules from an excited energy state to a lower energy state; which may typically be either a ground-energy state or an intermediate energy state. Assuming the energy transition is adequately sized, the emitted energy may be of the range of frequencies of visible light. Thus, step 370 marks the point at which visible light is emitted from the volume element 171 of visible light in the volume 170 by one iteration of the process cycle of laser-induced luminescence.

Step 370 also marks the end of one process cycle iteration. Recall that the iterative process of laser-induced luminescence began at step 320 by the selection of a desired volume element 171 in the volume 170 and the positioning of the lens 160 and first and second set of mirrors 130 and 140. One iteration of this process may be deemed to be completed at step 370 when luminescence takes effect at one volume element 171 in the volume 170, and visible light is emitted at that volume element 171.

The control module 150 may be signaled that one iteration of the process cycle has been completed at step 370. The control module 150 may receive input control signals from the various components of the three-dimensional display system 100 to the effect that one iteration of the process cycle has been completed. Alternatively, the control module 150 may keep time on an internal clock, and conclude one iteration is completed after a certain time has elapsed after the firing of the first laser element 110 and/or second laser element 120. The control module 150 may have other systems known to those of ordinary skill in the art for determining the completion of one process cycle. In any case, the control module 150 knows when one iteration of the process cycle of laser-induced luminescence is completed. Upon completion, the control module 150 may analyze the three-dimensional image data and iterate to a subsequent volume element 171 at which to induce luminescence.

At step 380 the control module 150 determines whether there is, in fact, a subsequent volume element 171 at which to induce luminescence. This determination may depend on the three-dimensional image data. If the three-dimensional image data describes a single static image, the control module 150 may first determine whether every volume element 171 described by the three-dimensional image data has been traversed at least once. If every volume element 171 described by the three-dimensional image data has not been traversed at least once, then the control module 150 may determine that there is at least one subsequent volume element 171 at which to induce luminescence, and the iterative process of laser-induced luminescence may repeat, starting again at step 320. If every volume element 171 described by the three-dimensional image data has been traversed at least once, then the control module 150 may further determine whether to refresh the image. The control module 150 may decide to refresh the image and continue to iterate through the process based on preset time limits or user input. On the other hand, if the three-dimensional image data describes a sequence of images, such as in an animation, then the control module 150 may determine whether there is another volume element 171 in the current image of the sequence of images that has not been traversed at least once and/or another image in the sequence of images that has not yet been displayed by the three-dimensional display system 100. If the answer to either question is yes, then the iterative process of laser-induced luminescence may repeat, starting again at step 320. If there are no subsequent volume elements 171 at which to induce luminescence, then the three-dimensional display system proceeds to step 390.

At step 390 the three-dimensional display system has determined there are no subsequent volume elements 171 to traverse, and no further iterations of the laser-induced luminescence process to repeat. At this point the three-dimensional image display system may either reset or shut down. The process is finished with regards to the present three-dimensional image, and the three-dimensional display system 100 is ready to display an additional three-dimensional image or animation, described by additional three-dimensional image data, repeat the same three-dimensional image or animation, or shut down.

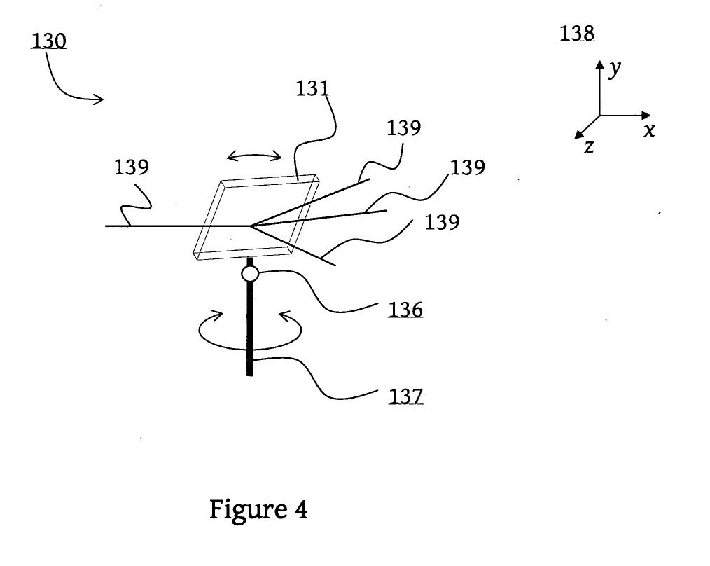

FIG. 4 illustrates a more detailed view of the first set of mirrors 130 according to the preferred embodiment of the present invention. The first set of mirrors 130 may be substantially similar to the second set of mirrors 140 in many respects. Thus, FIG. 4 may be considered to be a more detailed view of both the first and second sets of mirrors, 130 and 140. Additionally, an xyz coordinate axis 138 is pictured for ease of reference.

In the preferred embodiment shown in FIG. 4, there is a first mirror 131. While one mirror is preferred, a plurality of mirrors may be used if desirable. Likewise, while the first mirror 131 of the first set of mirrors 130 is illustrated as rectangular in FIG. 4, the mirror may also be circular, triangular, octagonal, or any other geometric shape. The first set of mirrors 130 also includes a pivot 136 and a pivot support 137.

The first mirror 131 is directly connected to the pivot 136. The system of connection may be any known to those of ordinary skill in the art, including, but not limited to, industrial adhesive, glue, mounting brackets, magnets, Velcro, and welding. The pivot 136 is connected to both the first mirror 131 and the pivot support 137. The pivot may be connected to the control module 150 (not shown) with a system to allow the two devices to communicate with one another. Such a system may include, but is not limited to, electrical wiring and wireless communication. The first mirror 131 is connected to the pivot 136 in such a way as to allow the first mirror 131 to rotate about the y axis of the pivot 136. In FIG. 4, this rotational ability is illustrated through an arc around the y axis. Additionally, the first mirror 131 is connected to the pivot 136 in such a way as to allow the first mirror 131 to rotate about the z axis of the pivot 136. In FIG. 4, this rotational ability is illustrated through an arc around the z axis.

In operation, a laser beam 139 is reflected off of the first mirror 131 and into the volume 170 (not shown). The laser beam 139 may correspond to the first laser beam 101 where FIG. 4 is considered to be an illustration of the first set of mirrors 130. Alternatively, the laser beam 139 may correspond to the second laser beam 102 where FIG. 4 is considered to be an illustration of the second set of mirrors 140. In the example situation illustrated in FIG. 4, the laser beam 139 enters along the direction of the x axis and intersects with the first mirror 131. The laser beam 139 reflects off of the first mirror 131 towards the volume 170 (not shown) at an angle. The angle at which the laser beam 139 reflects off of the first mirror 131 depends upon the angle at which the first mirror 131 sits upon the pivot 136. FIG. 4 illustrates this dependency with a plurality of potential vectors that the laser beam 139 may follow upon reflection given the plurality of potential angles at which the first mirror 131 may sit upon the pivot 136. These vectors are for illustrative purposes only, and do not represent the full range of laser beam 139 vectors possible. Indeed, it is the aim of the set of mirrors 130 to be able to reflect the incoming laser beam 139 off of the first mirror 131 along any and every possible xyz vector that may take the laser beam into the volume 170.

In alternative embodiments, the first set of mirrors 130 (or second set of mirrors 140) may include a plurality of mirrors. The first set of mirrors 130 (or second set of mirrors 140) may achieve the versatility of laser beam 139 vector reflection and projection along xyz vectors in different, or additional, ways. In one alternative embodiment, there may be a plurality of pivots 136 which may be connected to a plurality of pivot supports 137 with a system to allow the pivots 136 and the first mirror 131 to rotate about the y axes of the pivot supports 137. Such a connection system may be coupled with an automated rotation system, such as with a motor or other similar device. Furthermore, there may be a system for the motor, or other such automated rotation system, to communicate with the control module 150 (not shown), similar to the system with which the slide 134 is connected to the control module 150, such that control module 150 may communicate and regulate rotation. The alternative or added functionality of a plurality of mirrors in the first set of mirrors 130 or second set of mirrors 140 suffices to give the plurality of mirrors 131 the ability to reflect and project the laser beam 139 along additional xyz vectors.

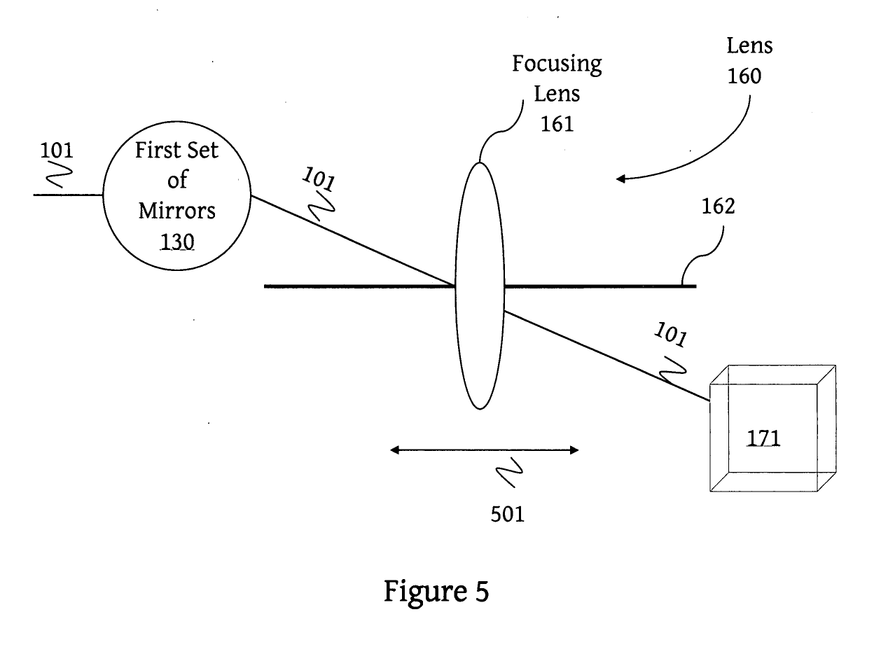

FIG. 5 illustrates a more detailed view of the lens 160, according to the preferred embodiment of the present invention. The lens 160 includes a focusing lens 161, which may be a convex lens, and a horizontal track 162. A double direction arrow 501 illustrates the range of motion the lens 161 may take along the horizontal track 162. Though not shown, and not essential to an understanding of the present invention, the lens 160 may also have a system to further support both the horizontal track 162 and convex lens 161.

The focusing lens 161 is connected to the horizontal track 162 with a system to allow the focusing lens 161 to move along the horizontal track 162, as illustrated by the double direction arrow 501. Such a connection system may be coupled with an automated rotation system, such as with a motor or other similar device. Furthermore, there may be a system for the motor, or other such automated rotation system, to communicate with the control module 150 (not shown) such that control module 150 may communicate and regulate the movement.

In operation, the focusing lens 161 moves back and forth along the horizontal track 162 in order to focus the first laser beam 101 on the volume element 171 in the volume 170 (not shown). As FIG. 5 illustrates, the first laser beam 101 is typically directed to the lens 160 from the first set of mirrors 130. The first laser beam 101 is focused through the focusing lens 161 on the desired volume element 171 in the volume 170. Whereas the first set of mirrors 130 may direct the first laser beam 101, the lens 160 typically focuses the first laser beam 101, affecting how far into the volume 170 the first laser beam 101 proceeds before inducing a plasma. Target molecules resident at the focal point of the first laser beam 101 at the volume element 171 are ionized by the first laser beam 101 and put into a plasma state. After the first laser beam 101 is focused through the lens 160, the first laser beam 101 transfers its energy to the target molecules in the volume element 171, thereby putting the target molecules at that volume element 171 into a plasma state.

The lens 160 may change how far into the volume 170 the first laser beam 101 proceeds before transferring its energy to the target molecules and inducing a plasma by changing the position of the focusing lens 161 along the horizontal track 162. The double direction arrow 501 illustrates the range of motion the focusing lens 161 may take along the horizontal track 162 to change position. The control module 150 (not shown) may send output control signals to the lens 160 in order to effect changes in position, according to the three-dimensional image data that the control module 150 is currently operating to display. Thus, the control module 150 may change the focus of the lens 160 by moving the focusing lens 161 along the horizontal track 162.

In alternative embodiments, the lens 160 may change its focus in different, or additional, ways. In the first alternative embodiment, there may be a plurality of focusing lenses 161 used to handle different distance ranges. The focal length of each focusing lens 161 may also be different in this alternative embodiment. In another alternative embodiment, the focus of the lens 160 may be changed electronically. For example, the focal properties may be varied by applying a voltage to the focusing lens 161. In each embodiment, the control module 150 may change the focus of the focusing lens 161, either by moving a focusing lens 161 along the horizontal track 162, or by changing which focusing lens 161 is used, or by changing the voltage or current applied to the focusing lens 161, or through some other method known to those of ordinary skill in the art.

As detailed above, one or more embodiments of the present invention relates to a three-dimensional display system. Although visualization systems exist, most prior development has been in two dimensions, or in two-dimensional systems which only produce the appearance of three-dimensionality. True three-dimensional volumetric systems are rare, and usually use spinning screens or rotating objects to produce the appearance of a three-dimensional image of those three-dimensional systems that forego the use of rotation, most are constrained within small enclosures or require complex solid or liquid mediums to operate within. One or more embodiments of the present invention relate to a three-dimensional display system that promises to project an image into a volume without many of the downsides of earlier machines. One or more embodiments of the present invention works without the need for spinning screens or small enclosures. One or more embodiments of the present invention also works without complex solid or liquid medium. Instead, the three-dimensional display system described by one or more embodiments of the present invention, and detailed above, operates to avoid some of the limitations of the prior art by activating target molecules in a gaseous medium.

While particular elements, embodiments, and applications of the present invention have been shown and described, it is understood that the invention is not limited thereto because modifications may be made by those skilled in the art, particularly in light of the foregoing teaching. For instance, the first laser beam 101 may pass through the lens 160 and set of mirrors 130 in reverse order; or the set of mirrors 130 may encompass the lens 160 within the plurality of mirrors 131 of an alternative embodiment. It is therefore contemplated by the appended claims to cover such modifications and incorporate those features which come within the spirit and scope of the invention.

What is claimed is:

1. A system for displaying a three-dimensional image, said system comprising:
a first laser element, wherein said first laser element focuses a first laser beam on a volume element in a volume, wherein said first laser beam induces a plasma at said volume element in said volume, wherein said volume is composed of target molecules characterized by energy state transitions, wherein said energy state transitions are sufficiently sizeable such that visible light emits upon an energy state transition from an excited energy state to a lower energy state;
a second laser element, wherein said second laser element passes a second laser beam through said volume element, exciting said target molecules into said excited energy state, wherein said target molecules emit visible light upon transition from said excited energy state to a lower energy state;
a control module, wherein said control module modifies the direction and intersection of said first laser beam and said second laser beam.

2. The system as claimed in claim 1, wherein said volume is composed of a gas medium.

3. The system as claimed in claim 1, wherein said volume is composed of an air medium.

4. The system as claimed in claim 1, further comprising a lens, wherein said first laser element focuses the first laser beam through said lens.

5. The system as claimed in claim 1, further comprising a plurality of mirrors, wherein said first and second laser beams are reflected off of said plurality of mirrors as necessary in order to scan through said volume.

6. The system as claimed in claim 5, wherein said control module modifies the direction and intersection of said first and second laser beams by changing the orientations of said plurality of mirrors.

7. The system as claimed in claim 1, further comprising a power source, wherein said power source provides power to said control module and said first and second laser elements.

8. A method for displaying a three-dimensional image, said method comprising the steps of:
forming a volume, wherein said volume is composed of target molecules characterized by energy state transitions, wherein said energy state transitions are sufficiently sizeable such that visible light emits upon an energy state transition from an excited energy state to a low energy state;
focusing a first laser beam from a first laser element on a volume element in a volume to induce a plasma, wherein said volume is composed of target molecules characterized by energy state transitions, wherein said energy state transitions are sufficiently sizeable such that visible light emits upon an energy state transition from an excited energy state to a lower energy state;
focusing a second laser beam from a second laser element on said target molecules in said volume element, wherein said target molecules are excited into an excited energy state, wherein said target molecules emit visible light upon a transition from said excited energy state to a lower energy state;
modifying the direction and intersection of said first laser beam and said second laser beam.

9. The method for displaying a three-dimensional image described in claim 8, wherein said volume is composed of a gas medium.

10. The method for displaying a three-dimensional image described in claim 8, wherein said volume is composed of an air medium.

11. The method for displaying a three-dimensional image described in claim 8, wherein said first laser beam is focused through a lens.

12. The method for displaying a three-dimensional image described in claim 8, further comprising the step of reflecting said first and second laser beams off of a plurality of mirrors as necessary in order to scan through said volume, wherein the direction and intersection of said first and second laser beams is modified by changing the orientations of said plurality of mirrors.

13. The method for displaying a three-dimensional image described in claim 12, further comprising the step of providing power to said first and second laser elements.
